(19) United States
(12) Patent Application Publication
(10) Pub. No.: US 2023/0350666 A1
(43) Pub. Date: Nov. 2, 2023

(54) SYSTEMS AND METHODS FOR EXECUTING FIRMWARE UPGRADES

(71) Applicant: SCHNEIDER ELECTRIC IT CORPORATION, Foxboro, MA (US)

(72) Inventors: Wen-Chun Peng, New Taipei City (TW); Cheng-Yi Huang, Shanghai (TW); Chaocheng Yen, New Taipei City (TW)

(21) Appl. No.: 18/221,136

(22) Filed: Jul. 12, 2023

Related U.S. Application Data
(63) Continuation-in-part of application No. PCT/CN2021/117732, filed on Sep. 10, 2021.

(51) Int. Cl. G06F 8/65; G06F 9/4401

(52) U.S. Cl. CPC G06F 8/65; G06F 9/4403

(57) ABSTRACT

Examples of the disclosure include a bootloader system including a volatile memory, a first non-volatile memory configured to store a first bootloader, a second non-volatile memory configured to store a second bootloader, and a microprocessor configured to control, responsive to executing the first bootloader, the volatile memory to receive an updated second bootloader and provide the updated second bootloader to the second non-volatile memory, and control the second non-volatile memory to update the second bootloader with the updated second bootloader.

### CROSS-REFERENCE TO RELATED APPLICATIONS

This application claims priority under 35 U.S.C. § 365(c) to and is a bypass continuation-in-part application of International Application Serial No. PCT/CN2021/117732, titled “COST EFFECTIVE FIRMWARE UPGRADE ALGORITHM FOR RESOURCE CONSTRAINED MICROPROCESSORS,” filed on Sep. 10, 2021, which is hereby incorporated by reference in its entirety.

### BACKGROUND

### 1. Field of the Disclosure

At least one example in accordance with the present disclosure relates generally to microprocessors.

### 2. Discussion of Related Art

Microprocessors may be implemented in various systems, such as embedded systems. Microprocessors may include volatile memory, such as RAM, and non-volatile memory, such as flash memory. Generally, the price of a microprocessor increases as the size of either type of memory increases. Non-volatile memory may be more expensive than volatile memory. Some cost-effective microprocessors may therefore include smaller non-volatile memory and larger volatile memory.

### SUMMARY

According to at least one aspect of the present disclosure, a bootloader system is provided including a volatile memory, a first non-volatile memory configured to store a first bootloader, and a second non-volatile memory configured to store a second bootloader, wherein the first bootloader, when executed by a microprocessor, causes the microprocessor to control at least one of the volatile memory or the second non-volatile memory to receive an updated second bootloader and pass the updated second bootloader through the at least one of the volatile memory or the second non-volatile memory to the second non-volatile memory.

According to at least one aspect of the disclosure, one or more non-transitory computer-readable media storing thereon sequences of computer-executable instructions are provided, the sequences of computer-executable instructions including instructions that, when executed, perform a computer-implemented method comprising writing a bootloader from a first non-volatile memory to a first volatile memory, receiving an updated bootloader in a second volatile memory, passing the updated bootloader to a second non-volatile memory, and writing the updated bootloader to the first non-volatile memory from the second non-volatile memory.

In some examples, the first non-volatile memory and the second non-volatile memory are portions of a single non-volatile memory element. In various examples, the first volatile memory is the second volatile memory.

According to at least one aspect of the disclosure, a method of assembling a bootloader system is provided comprising providing a first non-volatile memory, providing a microprocessor having a volatile memory and a second non-volatile memory, the microprocessor being configured to write a bootloader from the first non-volatile memory to the volatile memory, receive an updated bootloader in the volatile memory, and pass the updated bootloader through the volatile memory to the first non-volatile memory; and coupling the first non-volatile memory to the microprocessor.

According to at least one aspect of the disclosure, a bootloader system includes a first memory, a second memory configured to store a first bootloader, and a third memory configured to store a second bootloader, wherein the first memory receives an updated second bootloader and passes the updated second bootloader to the third memory.

According to at least one aspect of the present disclosure, a bootloader system is provided comprising a volatile memory, a first non-volatile memory configured to store a first bootloader, a second non-volatile memory configured to store a second bootloader, and a microprocessor configured to control, responsive to executing the first bootloader, the volatile memory to receive an updated second bootloader and provide the updated second bootloader to the second non-volatile memory, and control the second non-volatile memory to update the second bootloader with the updated second bootloader.

In at least one example, the volatile memory is random-access memory. In at least one example, the first non-volatile memory and the second non-volatile memory are each flash memory. In at least one example, the microprocessor includes the volatile memory and the first non-volatile memory. In at least one example, the second non-volatile memory is external to the microprocessor. In at least one example, the microprocessor is further configured to copy, responsive to executing the first bootloader, the second bootloader from the second non-volatile memory to the volatile memory. In at least one example, the microprocessor is further configured to write, responsive to executing the second bootloader in the volatile memory, the updated second bootloader to the second non-volatile memory.

In at least one example, the microprocessor is further configured to replace, responsive to executing the second bootloader in the volatile memory and responsive to writing the updated second bootloader to the second non-volatile memory, the second bootloader with the updated second bootloader. In at least one example, the microprocessor is further configured to write, responsive to replacing the second bootloader with the updated second bootloader, a validity signature associated with the updated second bootloader to the second non-volatile memory. In at least one example, the microprocessor is further configured to invalidate, prior to replacing the second bootloader with the updated second bootloader, a validity signature associated with the second bootloader. In at least one example, the second non-volatile memory is configured to store an application, and the microprocessor is configured to execute the application while the second bootloader is being updated.

According to at least one example of the disclosure, a method of controlling a bootloader system including a volatile memory, a first non-volatile memory configured to store a first bootloader, a second non-volatile memory configured to store an application to control operation of a device and a second bootloader is provided, the method comprising controlling, responsive to executing the first bootloader, the volatile memory to receive an updated second bootloader and provide the updated second bootloader to the second non-volatile memory, and controlling the second non-volatile memory to update the second bootloader with the updated second bootloader.

In at least one example, the method includes copying, responsive to executing the first bootloader, the second bootloader from the second non-volatile memory to the volatile memory.

In at least one example, the method includes writing, responsive to executing the second bootloader in the volatile memory, the updated second bootloader to the second non-volatile memory. In at least one example, the method includes replacing, responsive to executing the second bootloader in the volatile memory and responsive to writing the updated second bootloader to the second non-volatile memory, the second bootloader with the updated second bootloader.

In at least one example, the method includes writing, responsive to replacing the second bootloader with the updated second bootloader, a validity signature associated with the updated second bootloader to the second non-volatile memory. In at least one example, the method includes invalidating, prior to replacing the second bootloader with the updated second bootloader, a validity signature associated with the second bootloader.

According to at least one example of the disclosure, one or more non-transitory computer-readable media storing thereon sequences of computer-executable instructions for controlling a bootloader system including a volatile memory, a first non-volatile memory configured to store a first bootloader, a second non-volatile memory configured to store an application to control operation of a device and a second bootloader is provided, the sequences of computer-executable instructions including instructions that, when executed, perform a computer-implemented method comprising controlling, responsive to executing the first bootloader, the volatile memory to receive an updated second bootloader and provide the updated second bootloader to the second non-volatile memory, and controlling the second non-volatile memory to update the second bootloader with the updated second bootloader.

In at least one example, the method includes copying, responsive to executing the first bootloader, the second bootloader from the second non-volatile memory to the volatile memory. In at least one example, the method includes writing, responsive to executing the second bootloader in the volatile memory, the updated second bootloader to the second non-volatile memory. In at least one example, the method includes replacing, responsive to executing the second bootloader in the volatile memory and responsive to writing the updated second bootloader to the second non-volatile memory, the second bootloader with the updated second bootloader. In at least one example, the method includes writing, responsive to replacing the second bootloader with the updated second bootloader, a validity signature associated with the updated second bootloader to the second non-volatile memory. In at least one example, the method includes invalidating, prior to replacing the second bootloader with the updated second bootloader, a validity signature associated with the second bootloader. In at least one example, the computer-implemented method includes executing the application while the second bootloader is being updated.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a block diagram of an uninterruptible power supply according to an example;

FIG. 2 illustrates a block diagram of a bootloader system according to an example;

FIG. 3 illustrates a block diagram of a bootloader system according to another example;

FIG. 4 illustrates a block diagram of a bootloader system according to another example;

FIG. 5 illustrates a process of executing a first bootloader according to an example; and

FIG. 6 illustrates a process of executing a second bootloader according to an example.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

As discussed above, microprocessors may be implemented in various systems, such as embedded systems. For example, a power device, such as an uninterruptible power supply (UPS), may include one or more microprocessors. A microprocessor of the UPS may control components of the UPS, such as an LCD screen on the UPS that displays relevant output information to users. Although the principles of the disclosure apply to microprocessors in various systems, including embedded systems, particular examples are given with respect to a microprocessor controlling a UPS LCD screen for purposes of illustration. However, no limitation is implied by these examples, and the principles of the disclosure are applicable to various systems implementing microprocessors.

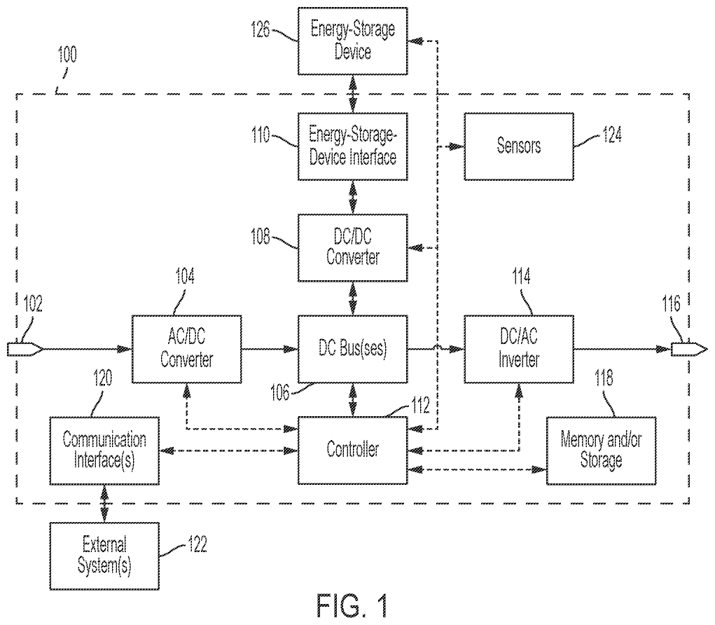

For example, FIG. 1 is a block diagram of a UPS 100 according to an example. The UPS 100 includes an input 102, an AC/DC converter 104, one or more DC busses 106, a DC/DC converter 108, an energy-storage-device interface 110, at least one controller 112 (“controller 112”), a DC/AC inverter 114, an output 116, a memory and/or storage 118, one or more communication interfaces 120 (“communication interfaces 120”), which may be communicatively coupled to one or more external systems 122 (“external systems 122”), and one or more voltage sensors and/or current sensors 124 (“sensors 124”).

The input 102 is coupled to the AC/DC converter 104 and to an AC power source (not pictured), such as an AC mains power supply. The AC/DC converter 104 is coupled to the input 102 and to the one or more DC busses 106, and is communicatively coupled to the controller 112. The one or more DC busses 106 are coupled to the AC/DC converter 104, the DC/DC converter 108, and to the DC/AC inverter 114, and are communicatively coupled to the controller 112. The DC/DC converter 108 is coupled to the one or more DC busses 106 and to the energy-storage-device interface 110, and is communicatively coupled to the controller 112. The energy-storage-device interface 110 is coupled to the DC/DC converter 108, and is configured to be coupled to at least one energy-storage device 126 and/or another energy-storage device. In some examples, the energy-storage-device interface 110 is configured to be communicatively coupled to the controller 112.

In some examples, the UPS 100 may be external to the at least one energy-storage device 126 and may be coupled to the at least one energy-storage device 126 via the energy-storage-device interface 110. In various examples, the UPS 100 may include one or more energy-storage devices, which may include the energy-storage device 126. The energy-storage device 126 may include one or more batteries, capacitors, flywheels, or other energy-storage devices in various examples.

The DC/AC inverter 114 is coupled to the one or more DC busses 106 and to the output 116, and is communicatively coupled to the controller 112. The output 116 is coupled to the DC/AC inverter 114, and to an external load (not pictured). The controller 112 is communicatively coupled to the AC/DC converter 104, the one or more DC busses 106, the DC/DC converter 108, the energy-storage-device interface 110, the DC/AC inverter 114, the memory and/or storage 118, the communication interfaces 120, and/or the energy-storage device 126. The sensors 124 are communicatively coupled to the controller 112 and may be coupled to one or more other components of the UPS 100, such as the input 102, the AC/DC converter 104, the one or more DC busses 106, the DC/DC converter 108, the energy-storage-device interface 110, the DC/AC inverter 114, and/or the output 116.

The input 102 is configured to be coupled to an AC mains power source and to receive input AC power having an input voltage level. The UPS 100 is configured to operate in different modes of operation based on the input voltage of the AC power provided to the input 102. The controller 112 may determine a mode of operation in which to operate the UPS 100 based on whether the input voltage of the AC power is acceptable. The controller 112 may include or be coupled to one or more sensors, such as the sensors 124, configured to sense parameters of the input voltage. For example, the sensors 124 may include one or more voltage and/or current sensors coupled to the input 102 and being configured to sense information indicative of a voltage at the input 102 and provide the sensed information to the controller 112.

When AC power provided to the input 102 is acceptable (for example, by having parameters, such as an input voltage value, that meet specified values, such as by falling within a range of acceptable input voltage values), the controller 112 controls components of the UPS 100 to operate in a normal mode of operation. In the normal mode of operation, AC power received at the input 102 is provided to the AC/DC converter 104. The AC/DC converter 104 converts the AC power into DC power and provides the DC power to the one or more DC busses 106. The one or more DC busses 106 distribute the DC power to the DC/DC converter 108 and to the DC/AC inverter 114. The DC/DC converter 108 converts the received DC power and provides the converted DC power to the energy-storage-device interface 110. The energy-storage-device interface 110 receives the converted DC power, and provides the converted DC power to the energy-storage device 126 to charge the energy-storage device 126. The DC/AC inverter 114 receives DC power from the one or more DC busses 106, converts the DC power into regulated AC power, and provides the regulated AC power to the output 116 to be delivered to a load.

When AC power provided to the input 102 from the AC mains power source is not acceptable (for example, by having parameters, such as an input voltage value, that do not meet specified values, such as by falling outside of a range of acceptable input voltage values), the controller 112 controls components of the UPS 100 to operate in a backup mode of operation. In the backup mode of operation, DC power is discharged from the energy-storage device 126 to the energy-storage-device interface 110, and the energy-storage-device interface 110 provides the discharged DC power to the DC/DC converter 108. The DC/DC converter 108 converts the received DC power and distributes the DC power amongst the one or more DC busses 106. For example, the DC/DC converter 108 may evenly distribute the power amongst the one or more DC busses 106. The one or more DC busses 106 provide the received power to the DC/AC inverter 114. The DC/AC inverter 114 receives the DC power from the one or more DC busses 106, converts the DC power into regulated AC power, and provides the regulated AC power to the output 116.

In some examples, the sensors 124 may include one or more sensors coupled to one or more of the foregoing components such that a voltage and/or current of one or more of the foregoing components may be determined by the controller 112. The controller 112 may store information in, and/or retrieve information from, the memory and/or storage 118. For example, the controller 112 may store information indicative of sensed parameters (for example, input-voltage values of the AC power received at the input 102) in the memory and/or storage 118. In various examples, the controller 112 may include one or more microprocessors configured to execute instructions stored in one or more computer-readable media. The microprocessor(s) may include, or be coupled to, volatile and/or non-volatile memory. For example, the microprocessor(s) may include at least one flash-memory component and at least one RAM component, and may additionally be coupled to at least one external flash-memory component. The at least one external flash-memory component may be included in the memory and/or storage 118.

The controller 112 may further receive information from, and/or provide information to, the communication interfaces 120. The communication interfaces 120 may include one or more communication interfaces including, for example, user interfaces (such as display screens, touch-sensitive screens, keyboards, mice, track pads, dials, buttons, switches, sliders, light-emitting components such as light-emitting diodes, sound-emitting components such as speakers, buzzers, and so forth configured to output sound inside and/or outside of a frequency range audible to humans, and so forth), wired communication interfaces (such as wired ports), wireless communication interfaces (such as antennas), and so forth, configured to exchange information with one or more systems, such as the external systems 122, or other entities, such as human beings. For example, the communication interfaces 120 may include at least one LCD display screen configured to display information pursuant to control signals received from the controller 112. The external systems 122 may include any device, component, module, and so forth, that is external to the UPS 100, such as a server, database, laptop computer, desktop computer, tablet computer, smartphone, central controller or data-aggregation system, other UPS s, and so forth.

The controller 112 may therefore control operation of the UPS 100. For example, the controller 112 may include or be coupled to one or more memory elements configured to store computer-executable instructions that, when executed by at least one processor, cause the controller 112 to control operation of the UPS 100. For example, the controller 112 may include at least one microprocessor configured to execute such instructions. As discussed above, the microprocessor may include volatile and/or non-volatile memory.

The cost of some microprocessors increases with the size of the microprocessor's volatile and/or non-volatile memory. To reduce costs, some microprocessors are produced with smaller non-volatile memory and larger volatile memory, but are coupled to external non-volatile memory at least partially to compensate for the smaller non-volatile memory in the microprocessor. The external non-volatile memory may store application firmware for execution, such as application firmware to control an LCD screen. Using the UPS 100 as an example, the controller 112 may include at least one microprocessor configured to execute application firmware to control an LCD screen of the communication interface 120, the application firmware being stored in non-volatile memory external to the at least one processor.

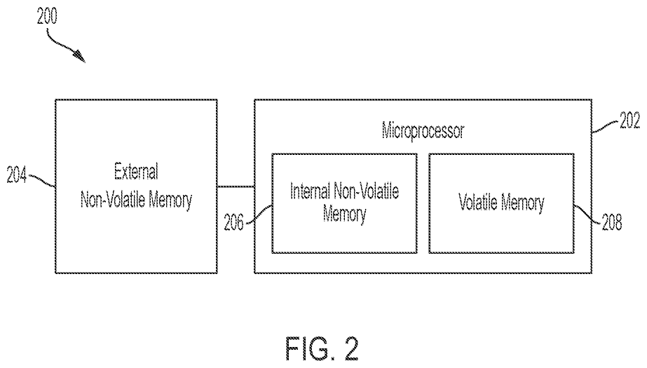

FIG. 2 illustrates a block diagram of a bootloader system 200 according to one example. The system 200 includes a microprocessor 202 and an external non-volatile memory element 204. In some examples, the external non-volatile memory element 204 may be implemented as a serial flash element coupled to the microprocessor 202 via a serial (for example, SPI) connection. The microprocessor 202 includes an internal non-volatile memory element 206 and an internal volatile memory element 208. In some examples, the internal non-volatile memory element 206 may be implemented as a flash element. In some examples, the internal volatile memory element 208 may be implemented as a RAM element. Although the principles of the disclosure are not limited to flash and/or RAM, and are more broadly applicable to non-volatile and volatile memory, respectively, examples are provided with respect to flash and RAM for purposes of illustration. Volatile memory and/or non-volatile memory may be referred to herein as non-transitory computer-readable media, which may include flash memory, RAM, and/or other forms of memory.

As discussed above, it may be financially advantageous for the external non-volatile memory element 204 to be relatively large. In one example, the external non-volatile memory element 204 may be approximately 8 MB, the internal non-volatile memory element 206 may be approximately 128 kB, and the internal volatile memory element 208 may be approximately 1 MB. Each of the memory elements 204-208 may execute different firmware.

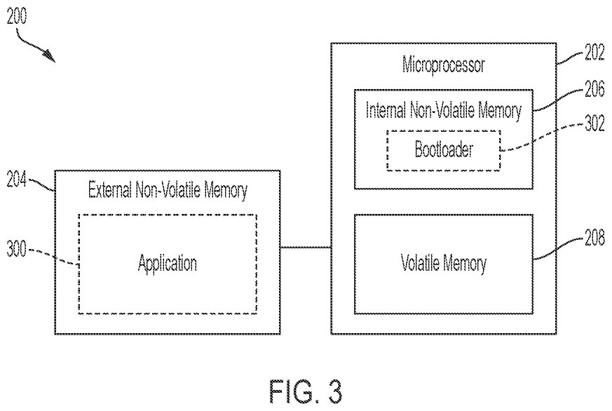

For example, FIG. 3 illustrates a block diagram of the bootloader system 200 in which the external non-volatile memory element 204 executes an application 300 and the internal non-volatile memory element 206 executes a bootloader 302. In one example, the external non-volatile memory element 204 stores the application 300 to be executed-in-place by the microprocessor 202. For example, the application 300 may be executed to control an LCD of the communication interfaces 120 to display relevant information, such as uninterruptible-power-uptime information. Whereas the external non-volatile memory element 204 stores the application 300, the internal non-volatile memory element 206 may store the bootloader 302 to initialize the bootloader system, update the application 300, and/or update the bootloader 302 itself.

For example, to upgrade the application 300 stored in the external non-volatile memory element 204, the bootloader 302 may first initialize peripherals of the microprocessor 202, such as an SPI connection between the microprocessor 202 and the external non-volatile memory element 204. The bootloader 302 may also configure the external non-volatile memory element 204 as a pure storage device, that is, the bootloader 302 may erase the content of the external non-volatile memory element 204. The bootloader 302 receives a new application from an external computing device (for example, from the external systems 122) and writes the new application to the region of the external non-volatile memory element 204 occupied by the application 300. Once the new application is written to the external non-volatile memory element 204, the bootloader 302 resets the microprocessor 202 and the external non-volatile memory element 204 begins to execute the new, updated application firmware.

However, while the external non-volatile memory element 204 is configured as a pure storage device for programming the new application, the external non-volatile memory element 204 may not be able to be used to execute any firmware that was previously stored in the external non-volatile memory element 204, such as the application 300, since the content of the external non-volatile memory element 204 has been erased. This may introduce inconveniences to a user. For example, while the application firmware of the UPS 100 is being updated, the microprocessor 202 may not be able to execute the application 300 nor the new application, since the application 300 is erased prior to beginning the application-firmware update.

In contrast, when external flash is configured for executing code in place, external flash is no longer writable. Accordingly, the internal non-volatile memory element 206 may be the only available storage to store the bootloader 302. Because the internal non-volatile memory element 206 may be relatively small in some examples (for example, 128 kB), the bootloader 302 may be constrained in a range of functionality that the bootloader 302 may execute. For example, where the application 300 is configured to control an LCD screen, the bootloader 302 may not have sufficient resources to execute the LCD-control aspects of the application 300 (for example, application-update-progress information, such as an estimated time of completion of the application update) while the bootloader 302 is executing a firmware-upgrade process. In other words, although the internal non-volatile memory element 206 may be large enough to store a bootloader 302 capable of executing a firmware-upgrade procedure, the bootloader 302 may not be capable of simultaneously executing the application 300. Accordingly, the LCD screen may be blank during a firmware-upgrade process, which users may not favor. Disadvantages may therefore arise during application-update operations.

Disadvantages may also arise during bootloader-update operations, that is, processes to update the bootloader 302 in the internal non-volatile memory element 206. To update the bootloader 302, the bootloader 302 may first configure the external non-volatile memory element 204 as a pure storage device. The microprocessor 202 may then receive a new bootloader and store the new bootloader to the external non-volatile memory element 204 temporarily. When the new bootloader is received, some aspects of the bootloader 302 running on the internal volatile memory element 208 may erase the internal non-volatile memory element 206, thereby erasing the old bootloader 302, and copy the new bootloader from the external non-volatile memory element 204 to the internal non-volatile memory element 206. When the copying operation is complete, the microprocessor 202 resets to switch execution to the new, updated bootloader.

However, if power to the bootloader system 200 is lost during the bootloader-update operation, the bootloader 302 may be corrupted. If the bootloader 302 is corrupted, the bootloader 302 may not execute properly or, in some cases, at all. Users may experience dissatisfaction if the bootloader 302 can no longer be executed because, for example, the application 300 has already been erased and can no longer be updated since the bootloader 302 cannot perform the update.

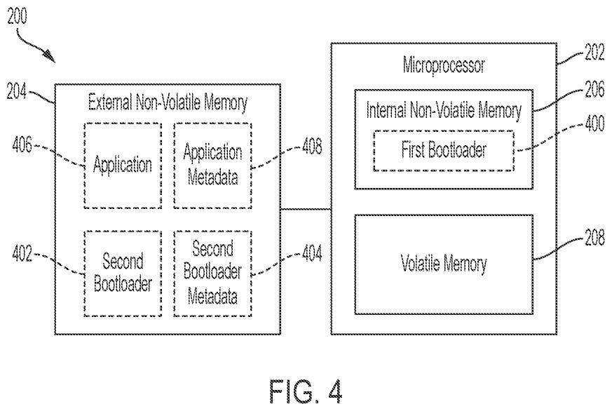

In view of the foregoing, examples discussed herein configure the bootloader system 200 to be capable of executing application firmware while the application firmware is being updated, and capable of updating a bootloader with a lower risk of corruption. FIG. 4 illustrates a block diagram of the bootloader system 200 according to an example. As illustrated in FIG. 4, the internal non-volatile memory element 206 stores a first bootloader 400 (also referred to as “FBL 400”). The external non-volatile memory element 204 stores a second bootloader 402 (also referred to as “SBL 402”) and associated second bootloader metadata 404 (also referred to as “SBL metadata 404”), and an application 406 and associated application metadata 408. In some examples, the second bootloader 402 includes the second bootloader metadata 404. Similarly, in some examples, the application 406 includes the associated application metadata 408.

As discussed below, the SBL 402 performs upgrades of the application 406 and of the SBL 402 itself, which can mitigate or eliminate the aforementioned disadvantages. Because the application 406 is executed in the external non-volatile memory element 204, which may be larger than the internal non-volatile memory element 206, the SBL 402 may be capable of executing the application 406 while the application 406 is being updated. Moreover, the FBL 400 reduces a risk of corruption of any of the memories 204-208, as discussed in greater detail below. In various examples, the FBL 400 may not require updating, and a risk of corruption is thereby minimized since the FBL 400 may be immune to errors that might otherwise occur during a firmware update. Although the SBL 402 may be updated on one or more occasions, and may be corrupted during an update, the FBL 400 can recover the SBL 402 to replace the corrupted SBL in various examples.

The application 406 may control operation of one or more components of a device in which the bootloader system 200 is implemented. For example, if the bootloader system 200 is implemented in the UPS 100, the application 406 may be executed to control an LCD of the communication interfaces 120 to display relevant information, such as uninterruptible-power-uptime information.

The SBL metadata 404 includes metadata descriptive of the SBL 402. In some examples, the SBL metadata 404 includes two types of information. A first type of information includes SBL-size information. The SBL-size information may indicate a size of the SBL 402 individually or in combination with the SBL metadata 404 itself. A second type of information includes SBL-signature information. The SBL-signature information may include a validity signature which indicates whether the SBL 402 is valid or not. The validity signature may be invalidated prior to updating the SBL 402. Invalidating the validity signature may flag the fact that the SBL 402 is not valid because the SBL 402 is currently being updated, and may be corrupted if executed. Once the update is complete, a validity signature may be rewritten to the SBL metadata 404 to indicate that the SBL 402 is again valid and capable of being executed.

Similarly, the application metadata 408 may include an application validity signature indicating whether or not the application 406 is valid. The application validity signature may be invalidated prior to updating the application 406, and the application validity signature may be rewritten after updating the application 406.

In some examples, the SBL-size information may be located at a beginning of the SBL metadata 404. The SBL-signature information may be located at an end of the SBL metadata 404. The SBL metadata 404 may be located at a beginning of the external non-volatile memory 204, followed by the SBL 402, the application metadata 408, and the application 406. Within the application metadata 408, the application validity signature may be located at an end of the application metadata 408.

In some examples, the SBL metadata 404 may include additional or different information. For example, the SBL metadata 404 may include application-address information. The application-address information may indicate, or be used to determine, a starting address of the application 406 and/or application metadata 408 in the external non-volatile memory 204. The application-address information may indicate an offset of the beginning of the application 406 or application metadata 408 from a known address of the SBL metadata 404. For example, consider an example in which the SBL metadata 404 is at a known address at the beginning of the external non-volatile memory 204, followed by the SBL 402, the application metadata 408, and the application 406. If the application-address information indicates an application offset of the beginning of the application metadata 408 from the beginning of the SBL metadata 404, a starting address of the beginning of the application metadata 408 may be a sum of the known starting address of the SBL metadata 404 plus the application offset.

Accordingly, regardless of what type and configuration of information the SBL metadata 404 includes (for example, including SBL-size information at the beginning of the SBL metadata 404 and SBL-signature information at the end of the SBL metadata 404 where the new SBL metadata is stored at the end of the external non-volatile memory 204, or including application-address information immediately before the SBL-size information where the new SBL metadata is stored immediately after the old SBL 402, or a different configuration), a location and size of a new SBL copied to the external non-volatile memory 204 may be determinable by another process.

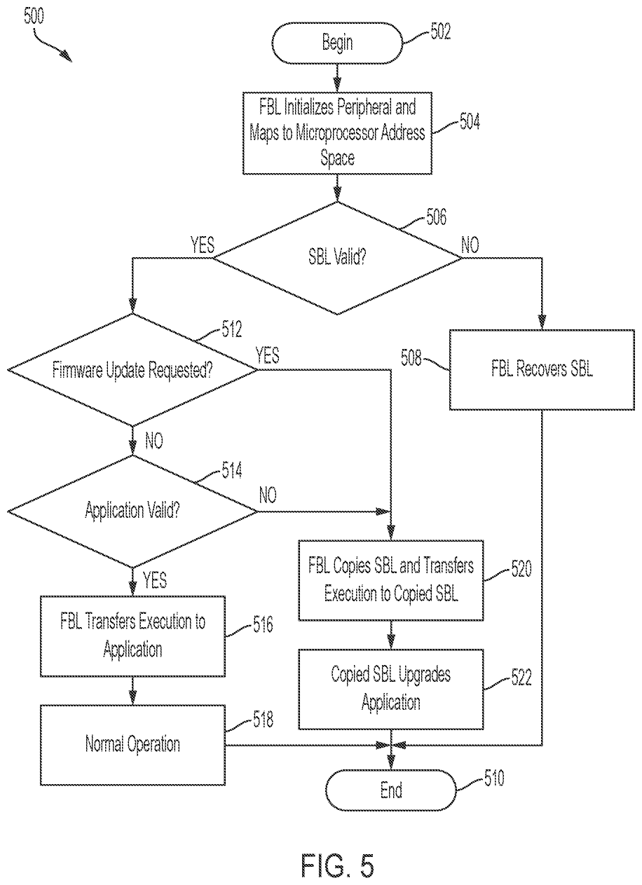

Operation of the FBL 400 will be described with respect to FIG. 5. FIG. 5 illustrates a process 500 performed by the microprocessor 202 while executing the FBL 400. The process 500 may be executed by the microprocessor 202 responsive to executing the FBL 400 when, for example, the microprocessor 202 is initially powered on. In some examples, the process 500 may be executed one or more times after the microprocessor 202 is powered on. As discussed below, the microprocessor 202 may be rebooted in various instances, such as after an update of the application 406 or the SBL 402, and the process 500 may be executed thereafter. Although the microprocessor 202 may perform the acts of the process 500 as the microprocessor 202 executes the FBL 400 and/or SBL 402, for purposes of clarity the following description may refer to acts as being performed by the FBL 400 and/or the SBL 402. For example, an act performed by the microprocessor 202 while the microprocessor 202 executes the FBL 400 may be referred to as an act performed by the FBL 400 itself for ease of explanation.

At act 502, the process 500 begins.

At act 504, the FBL 400 initializes a communication peripheral (for example, SPI) for controlling the external non-volatile memory 204. The FBL 400 also maps the external non-volatile memory 204 into an address space of the microprocessor 202, such that the microprocessor 202 can execute the firmware stored on the external non-volatile memory 204 (that is, execute the firmware “in place,” or “XIP”).

At act 506, the FBL 400 determines whether the SBL 402 is valid. As discussed above, the SBL metadata 404 may include SBL-signature information. The SBL-signature information may include a validity signature indicating that the SBL 402 is valid. If the SBL-signature information does not include a validity signature, then the FBL 400 may determine that the SBL 402 is not valid. For example, the validity signature may be invalidated prior to beginning an update of the SBL 402, and may not be rewritten to the SBL-signature information until the update is complete. If, for example, power is lost during the update procedure, then the update may not have been completed and the SBL 402 may be corrupted. Because the validity signature may have been invalidated and not subsequently rewritten due to the loss of power, the FBL 400 may determine that the SBL 402 is not valid (506 NO). Conversely, if a validity signature is present in the SBL-signature information, then the FBL 400 may determine that the SBL 402 is valid (506 YES). Accordingly, act 506 may include the FBL 400 accessing a location of the SBL metadata 404 known to contain SBL-signature information to determine whether the SBL 402 is valid.

If the FBL 400 determines that the SBL 402 is not valid (for example, because a valid validity signature is not present in the SBL-signature information of the SBL metadata 404) (506 NO), then the process 500 continues to act 508.

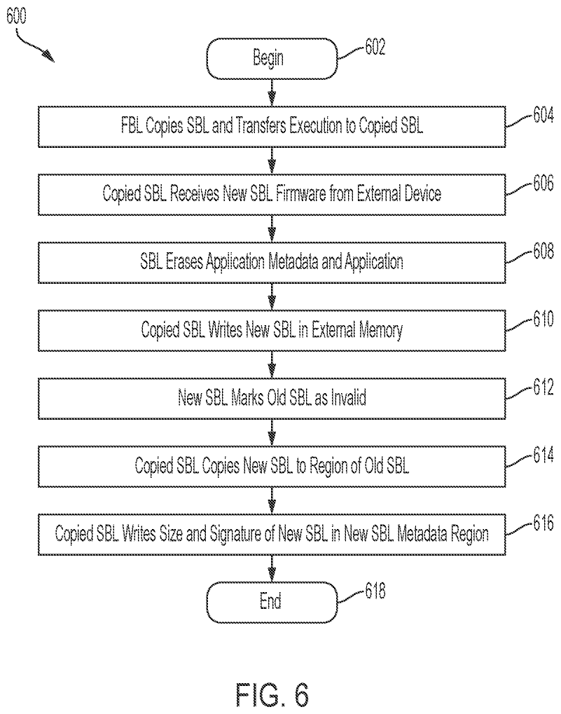

At act 508, the FBL 400 recovers the SBL 402. The FBL 400 may recover the SBL 402 by updating the corrupted SBL 402 with an updated SBL. Once the SBL 402 is updated, the SBL 402 may again be valid. A process of updating the SBL 402 is described below with respect to FIG. 6.

The process 500 then ends at act 510. In some examples, the process 500 may be re-executed after ending at act 510. In some examples, the process 500 may be re-executed from the beginning (for example, at act 502) or from a different act. For example, the process 500 may be re-executed starting at act 506.

Returning to act 506, if the SBL 402 is valid (506 YES), then the process 500 continues to act 512. The FBL 400 may determine that the SBL 402 is valid responsive to identifying a valid validity signature at an expected location in the SBL metadata 404.

At act 512, FBL 400 determines whether a request to update the application 406 firmware has been received. The request may originate from a device external to the device in which the bootloader system 200 is implemented. For example, where the bootloader system 200 is implemented in the UPS 100, the request may originate from one or more of the external systems 122. For example, the external systems 122 may include a server that pushes an application update via a network connection to one or more UPS s including the UPS 100. If no such request has been received (512 NO), then the process 500 continues to act 514.

At act 514, the FBL 400 determines whether the application 406 is valid. Determining whether the application 406 is valid may include determining whether a valid application validity signature is present in the application metadata 408. The FBL 400 may first determine an address of the application validity signature. As discussed above, in some examples, the application validity signature may begin in the application metadata 408 after the SBL 402 ends. In some examples, the FBL 400 may access the SBL-size information to determine a size of the SBL 402 and/or the SBL metadata 404. Because the FBL 400 knows a starting address of where the SBL metadata 404 begins, and knows a size of the SBL 402 and/or SBL metadata 404, the FBL 400 may calculate a starting address of the application metadata 408. If the FBL 400 determines that the application 406 is valid (for example, because a valid application validity signature is present in the application metadata 408) (514 YES), then the process 500 continues to act 516.

At act 516, the FBL 400 transfers execution to the application 406. That is, with the application 406 and SBL 402 being valid, the application 406 may be executed (for example, executed in place) by the bootloader system 200 (for example, by the microprocessor 202).

At act 518, once the FBL 400 transfers execution to the application 406, the bootloader system 200 may be in a normal mode of operation. As discussed below, while in the normal mode of operation, the bootloader system 200 may determine that the application 406 or SBL 402 should be updated. Examples of updating the application 406 and/or SBL 402 are provided below.

The process 500 then ends at act 510.

Returning to act 514, if the application 406 is not valid (514 NO), then the process 500 continues to act 520. For example, the FBL 400 may determine that the application 406 is not valid responsive to determining that no valid application validity signature is present in the application metadata 408. If the application is not valid (for example, because the application validity signature was previously erased during an interrupted application-updated procedure), the application may need to be updated.

At act 520, the FBL 400 copies the SBL 402 from the external non-volatile memory 204 to the internal volatile memory 208 and transfers execution to the SBL 402 in the internal volatile memory 208.

At act 522, the SBL 402 executing in the internal volatile memory 208 performs the application-upgrade procedure. The SBL 402 executing in the internal volatile memory 208 reconfigures the external non-volatile memory 204 as a pure storage device, receives the new application, and writes the new application to the external non-volatile memory 204. For example, the SBL 402 may receive a new application from an external computing device (for example, from the external systems 122) and write the new application to the region of the external non-volatile memory element 204 occupied by the application 406. Once the new application is written to the external non-volatile memory element 204, the SBL 402 resets the microprocessor 202 and the external non-volatile memory element 204 is capable of executing the new, updated application firmware.

The process 500 then ends at act 510. The microprocessor may be rebooted to execute the new application in normal operation as discussed above, with the SBL and application both being valid.

Since the available size of the volatile memory 208 (for example, 1 MB) may be greater than the available size of the internal non-volatile memory 206 (for example, 128 kB), the SBL 402 executing in the volatile memory 208 may be capable of performing more operations than the FBL 400 during the application-update operation. For example, the SBL 402 executing in the volatile memory 208 may be able to execute some functionality normally handled by the firmware of the application 406. In examples in which the application 406 includes LCD-control firmware, for example, the SBL 402 executing in the volatile memory 208 may control the LCD to display application-update information while also updating the application 406. The application-update information may include, for example, status information indicating progress of the application update. In other examples, the SBL 402 executing in the volatile memory 208 may perform other operations during the application-update operation. Consequently, examples provided herein enhance user satisfaction by retaining certain functionality normally handled by the application 406 while the application 406 is being updated.

The bootloader system 200 may also update the SBL 402. For example, the SBL 402 may be updated responsive to determining that the SBL 402 in the external non-volatile memory 204 is not valid, as discussed above, and/or responsive to receiving instructions to update the SBL 402 during normal operation. In some examples, an external device (for example, included in the external systems 122) may provide instructions to update the SBL 402.

FIG. 6 illustrates a process 600 of updating the SBL 402 according to an example. The process 600 may be executed by the bootloader system 200. The process 600 may be executed responsive to, for example, receiving instructions to update the SBL 402 from an external device.

At act 602, the process 600 begins.

At act 604, the FBL 400 copies the SBL 402 from the external non-volatile memory 204 to the volatile memory 208. The FBL 400 then transfers execution to the SBL 402 in the volatile memory 208, also referred to as the “copied SBL.”

At act 606, the SBL 402 in the volatile memory 208 receives new SBL firmware from an external device (for example, included in the external systems 122). The new SBL firmware may be received through, for example, a serial communication connection.

At act 608, the SBL 402 in the volatile memory 208 erases the application 406 and the application metadata 408 in the external non-volatile memory 204. In some examples, the SBL 402 in the volatile memory 208 may erase the application metadata 408 prior to erasing the application 406, such that the application 406 is marked as invalid (that is, by erasing the application metadata 408, which includes the application signature used for validity determinations) before the application 406 is erased.

At act 610, the SBL 402 in the volatile memory 208 writes the new SBL firmware (that is, the new SBL and the new SBL metadata) received at act 606 to the external non-volatile memory 204. For example, the SBL 402 in the volatile memory 208 may write the new SBL to the location in the external non-volatile memory 204 where the application 406 and the application metadata 408 previously were, that is, beginning immediately after the SBL 402 and the SBL metadata 404 in the external non-volatile memory 204 end.

At act 612, the copied SBL 402 in the volatile memory 208 marks the old SBL 402 in the external non-volatile memory 204 as invalid. For example, the SBL 402 in the volatile memory 208 may delete the SBL metadata region 404, which may include the SBL metadata signature used for validity determinations. In some examples, the copied SBL 402 in the volatile memory 208 receives the new SBL from an external device after marking the old SBL 402 as invalid, and subsequently programs the new SBL to the region of the external non-volatile memory 204 previously occupied by the application 406 and the application metadata 408 (for example, immediately after the SBL 402 and the SBL metadata 404 in the external non-volatile memory 204).

At act 614, the copied SBL 402 in the volatile memory 208 then copies the new SBL from the region of the external non-volatile memory 204 previously occupied by the application 406 and the application metadata 408 to the beginning of the external non-volatile memory 204, thereby overwriting the old SBL 402. Even if power were lost during this copying act, or the copying was otherwise interrupted, the new SBL is still stored in the region of the external non-volatile memory 204 previously occupied by the application 406 and the application metadata 408. Accordingly, upon rebooting, the FBL 400 would determine that the old SBL 402 is invalid, because the SBL metadata 404, which included the validity signature, was deleted prior to beginning the copying procedure. The FBL 400 would then be able to resume the copying procedure to complete overwriting the old SBL 402 with the new SBL.

At act 616, the copied SBL 402 in the volatile memory 208 writes the new SBL metadata information into the region of the external non-volatile memory 204 previously occupied by the now-deleted SBL metadata 404. The new SBL metadata may include, for example, the SBL size and SBL signature of the new SBL. Accordingly, only when the copying operation is fully complete can the new SBL, now located at beginning of the external non-volatile memory 204, be recognized as valid due to the presence of the new SBL metadata signature in the area of storage previously occupied by the old SBL metadata 404.

The process 600 then ends at act 618.

Accordingly, even if power is lost during an SBL-update operation (for example, the process 600), or the operation is otherwise interrupted or corrupted, it may be possible to execute a recovery operation to recover the SBL 402. Once power is restored to the bootloader system 200, or the bootloader system 200 is otherwise determining whether the SBL 402 is valid, the FBL 400 may detect that the SBL 402 is invalid pursuant to act 506 of the process 500. The process 600 may then be executed to update the SBL 402.

Although certain acts are illustrated as being executed sequentially, certain acts may be executed in parallel. For example, while the SBL is being updated and is receiving the new SBL from an external device, the new SBL data may be passed through the RAM to the external flash. For example, the SBL in RAM may receive a chunk of the new SBL data, pass the chunk to the external flash, and then receive a subsequent chunk of the new SBL data, such that the SBL in RAM does not have the entirety of the new SBL data at any one time. In other examples, however, the SBL in RAM may receive the entirety of the new SBL data prior to writing it to the external flash.

As discussed above, the principles of the disclosure are applicable to various forms of non-volatile memory, and are not limited to flash memory. Similarly, the principles of the disclosure are applicable to various forms of volatile memory, and are not limited to RAM. Example components illustrated as a single component may be implemented as several components in some examples. For example, the external flash may be implemented as several external non-volatile memory devices or elements, which may or may not be the same type of memory devices or elements. That is, in some examples, the external flash may be implemented by two or more non-volatile memories, which may include flash memories. Furthermore, as discussed above, the bootloader systems discussed herein may be implemented in any of various devices, and are not limited to embedded systems such as UPSs to control an LCD.

As discussed above, the bootloader system may receive a new application and/or a new SBL from an external device. In some examples, the external device transmits a unique ID with each of the new application and the new SBL indicating whether the transmittal is a new SBL or a new application. In some examples, the new firmware may be transmitted to the SBL in a special format, such as a firmware image including a header followed by encrypted firmware. The header may include a unique ID identifying the firmware image as a bootloader firmware image or an application firmware image.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A bootloader system comprising:
a volatile memory;
a first non-volatile memory configured to store a first bootloader;
a second non-volatile memory configured to store a second bootloader; and
a microprocessor configured to:
control, responsive to executing the first bootloader, the volatile memory to receive an updated second bootloader and provide the updated second bootloader to the second non-volatile memory, and
control the second non-volatile memory to update the second bootloader with the updated second bootloader.

2. The bootloader system of claim 1, wherein the volatile memory is random-access memory.

3. The bootloader system of claim 1, wherein the first non-volatile memory and the second non-volatile memory are each flash memory.

4. The bootloader system of claim 1, wherein the microprocessor includes the volatile memory and the first non-volatile memory.

5. The bootloader system of claim 1, wherein the second non-volatile memory is external to the microprocessor.

6. The bootloader system of claim 1, wherein the microprocessor is further configured to copy, responsive to executing the first bootloader, the second bootloader from the second non-volatile memory to the volatile memory.

7. The bootloader system of claim 1, wherein the microprocessor is further configured to write, responsive to executing the second bootloader in the volatile memory, the updated second bootloader to the second non-volatile memory.

8. The bootloader system of claim 7, wherein the microprocessor is further configured to replace, responsive to executing the second bootloader in the volatile memory and responsive to writing the updated second bootloader to the second non-volatile memory, the second bootloader with the updated second bootloader.

9. The bootloader system of claim 8, wherein the microprocessor is further configured to write, responsive to replacing the second bootloader with the updated second bootloader, a validity signature associated with the updated second bootloader to the second non-volatile memory.

10. The bootloader system of claim 8, wherein the microprocessor is further configured to invalidate, prior to replacing the second bootloader with the updated second bootloader, a validity signature associated with the second bootloader.

11. The bootloader system of claim 1, wherein the second non-volatile memory is configured to store an application, and wherein the microprocessor is configured to execute the application while the second bootloader is being updated.

12. A method of controlling a bootloader system including a volatile memory, a first non-volatile memory configured to store a first bootloader, a second non-volatile memory configured to store an application to control operation of a device and a second bootloader, the method comprising:
controlling, responsive to executing the first bootloader, the volatile memory to receive an updated second bootloader and provide the updated second bootloader to the second non-volatile memory; and
controlling the second non-volatile memory to update the second bootloader with the updated second bootloader.

13. The method of claim 12, further comprising copying, responsive to executing the first bootloader, the second bootloader from the second non-volatile memory to the volatile memory.

14. The method of claim 12, further comprising writing, responsive to executing the second bootloader in the volatile memory, the updated second bootloader to the second non-volatile memory.

15. The method of claim 14, further comprising replacing, responsive to executing the second bootloader in the volatile memory and responsive to writing the updated second bootloader to the second non-volatile memory, the second bootloader with the updated second bootloader.

16. The method of claim 15, further comprising writing, responsive to replacing the second bootloader with the updated second bootloader, a validity signature associated with the updated second bootloader to the second non-volatile memory.

17. The method of claim 15, further comprising invalidating, prior to replacing the second bootloader with the updated second bootloader, a validity signature associated with the second bootloader.

18. One or more non-transitory computer-readable media storing thereon sequences of computer-executable instructions for controlling a bootloader system including a volatile memory, a first non-volatile memory configured to store a first bootloader, a second non-volatile memory configured to store an application to control operation of a device and a second bootloader, the sequences of computer-executable instructions including instructions that, when executed, perform a computer-implemented method comprising:
controlling, responsive to executing the first bootloader, the volatile memory to receive an updated second bootloader and provide the updated second bootloader to the second non-volatile memory; and
controlling the second non-volatile memory to update the second bootloader with the updated second bootloader.

19. The one or more non-transitory computer-readable media of claim 18, the computer-implemented method further comprising copying, responsive to executing the first bootloader, the second bootloader from the second non-volatile memory to the volatile memory.

20. The one or more non-transitory computer-readable media of claim 18, the computer-implemented method further comprising writing, responsive to executing the second bootloader in the volatile memory, the updated second bootloader to the second non-volatile memory.

21. The one or more non-transitory computer-readable media of claim 20, the computer-implemented method further comprising replacing, responsive to executing the second bootloader in the volatile memory and responsive to writing the updated second bootloader to the second non-volatile memory, the second bootloader with the updated second bootloader.

22. The one or more non-transitory computer-readable media of claim 21, the computer-implemented method further comprising writing, responsive to replacing the second bootloader with the updated second bootloader, a validity signature associated with the updated second bootloader to the second non-volatile memory.

23. The one or more non-transitory computer-readable media of claim 21, the computer-implemented method further comprising invalidating, prior to replacing the second bootloader with the updated second bootloader, a validity signature associated with the second bootloader.

24. The one or more non-transitory computer-readable media of claim 18, wherein the computer-implemented method includes executing the application while the second bootloader is being updated.
